(19) United States
(12) Patent Application Publication
(10) Pub. No.: US 2005/0252114 A1
(43) Pub. Date: Nov. 17, 2005

(54) Device for sealing building apertures

(75) Inventor: Hermann Marschall, Nussdorf-Debant (AT)

Correspondence Address: LERNER AND GREENBERG, PA, P O BOX 2480, HOLLYWOOD, FL, 33022-2480, US

(73) Assignee: Heinrich Karre

(21) Appl. No.: 11/148,703

(22) Filed: Jun. 9, 2005

Related U.S. Application Data
(63) Continuation of application No. PCT/AT03/00363, filed on Dec. 5, 2003.

(30) Foreign Application Priority Data
Dec. 9, 2002 (AT) A 1837/2002

(51) Int. Cl. E06B 7/00

(52) U.S. Cl. 52/204.593

(57) ABSTRACT

A device for sealing openings in buildings is formed with a frame that can adapted or adjusted to the inner dimensions of the opening, and a sealing plate or panel that is fixed to the frame. At least one of the lateral faces of the frame that faces the opening in the building comprises an inflatable sealing element preferably running around the periphery. The sealing element is configured preferably as a flexible elastic sheath with an open cross-section and forms a closed chamber with at least one section of the frame.

### CROSS-REFERENCE TO RELATED APPLICATION

This is a continuing application, under 35 U.S.C. § 120, of copending international application No. PCT/AT2003/00363, filed Dec. 5, 2003, which designated the United States; this application also claims the priority, under 35 U.S.C. § 119, of Austrian patent application No. A 1837/2002, filed Dec. 9, 2002; the prior applications are herewith incorporated by reference in their entirety.

### BACKGROUND OF THE INVENTION

### FIELD OF THE INVENTION

The invention relates to a device for sealing building apertures with a frame that can be adjusted to the inner clearance of the aperture and a sealing plate that is firmly connected to the frame, wherein the frame has an inflatable sealing element extending preferably all around the periphery of at least one lateral surface turned toward the building aperture.

A device of similar type, described in German published patent application DE 4023286 A1, has a sealing frame comprising side profiles with an all-round sealing strip on their outer periphery. The side profiles can be pressed apart by tension components and against the soffits of the building apertures. Furthermore, the frame is provided with a cover plate tensioned over its surface. Diagonal bracings are provided for sealing the corner areas of the building aperture to be closed.

The prior art device is quite suitable to prevent floodwater from penetrating into the closed building aperture. However, the complex design of this known device does not enable a fast and simple mounting of the sealing device.

### SUMMARY OF THE INVENTION

It is accordingly an object of the invention to provide a device for sealing openings of buildings which overcomes the above-mentioned disadvantages of the heretofore-known devices and methods of this general type and which provides for a device for sealing building apertures that has a low dead weight, requires simple mounting, and can be adjusted to the surface pattern of the soffits of the building aperture.

With the foregoing and other objects in view there is provided, in accordance with the invention, a device for sealing a building aperture, comprising:
a frame configured for adjustment to an inner clearance of the aperture; and
a sealing plate firmly connected to said frame;
the frame having an inflatable sealing element forming at least one lateral surface facing towards a boundary surface of the building aperture, said sealing element having an open cross-section and forming a closed chamber with at least one frame part of said frame.

In other words, the objects of the invention are achieved by configuring the sealing element as preferably a rubber-elastic shell with an open cross-section that forms a preferably closed gas-tight chamber with at least one frame part, wherein due to the excess pressure in the chamber, the shell presses against the soffit of the building aperture and forms with it the main sealing area of the building aperture. Due to the excess pressure, the sealing device can be adjusted to the dimensional deviations and unevenness on the soffits of the building apertures. Moreover, the sealing device seals the building aperture hermetically and prevents the entry of solid, gaseous and liquid substances.

Apart from that, the mounting process of the sealing device requires no preparatory work. The frame of the sealing device that is adjusted to the size of the building apertures has merely to be inserted in the building aperture. The building aperture is then locked and sealed by simply blowing up the inflatable sealing element.

According to an embodiment of the invention, the sealing element is designed as a preferably rubber-elastic shell with an open cross-section that forms a closed gas-tight chamber with at least one frame part. In doing so, due to the excess pressure in the chamber, the shell presses against the soffit of the building aperture and forms with it the main sealing area of the building aperture.

According to a preferred embodiment of the invention, the frame comprises a supporting frame structure that forms together with the sealing element a gas-tight chamber, which can be arranged between the building aperture and the frame structure. It has proved to be particularly advantageous if the sealing element is designed with a substantially semi-circular profile cross-section. The supporting frame structure, in addition to forming a gas-tight chamber with the sealing element, also imparts the required stability to the sealing device enabling a fixed connection with the brickwork. A frame structure of this type can be compared with the principle of a tubeless tire wherein the supporting frame structure would correspond to the rim and the rubber-elastic shell to the car tire.

According to another embodiment of the invention, the frame comprises an undercut, preferably flexible frame profile, into which the tubular sealing element is guided so as to ensure a preferably secure seating of the sealing element on the frame and to prevent the sealing element from slipping while mounting the sealing device.

Moreover, according to a particularly preferred embodiment of the invention, the frame has a supporting frame structure that is tightly connected to the frame profile and/or the sealing element. This increases the stability and thus the impermeability of the sealing device.

There are several options for connecting the frame to the sealing plate. In one embodiment of the invention, in which the complete sealing device is arranged in the building aperture such that it does not protrude over the outer wall of the building, the frame on the lateral surfaces of the sealing plate is tightly connected, preferably glued to the sealing plate all around the periphery.

Alternatively the frame can also be tightly connected, preferably glued to a cover surface of the sealing plate. It has proved to be advantageous, for instance in case of flood water, to distribute the pressure acting on the sealing plate if the sealing plate is larger than the building aperture so that the sealing plate rests at least partly against the outer wall of the building. In this manner the pressure applied by the floodwater is diverted to the outer wall of the building, thus taking the pressure off of the sealing element. For the purpose of preventing the entry of liquid or gaseous substances between the outer wall of the building and the sealing plate, preferably rubber-elastic sealings are arranged, according to a preferred embodiment of the invention, between the part/s of the sealing plate overlapping the building aperture and the outer wall of the building.

For the purpose of sealing even the various corners of the building aperture, another embodiment of the invention provides additional sealing parts for the sealing element in the corner areas of the building aperture. Alternatively, for this purpose the sealing element in the corner areas of the building aperture can be mitered. In this case, the two sealing elements are glued, preferably vulcanized together on their corresponding cut surfaces.

In another embodiment of the invention, the sealing element, in its deflated state, has a projection in at least one corner area of the frame, i.e. the sealing element in the area of the projection is broader than the remaining areas. Assuming that sealing elements without projections in the corner areas have to undergo a larger expansion than the sealing elements on the lateral surfaces for the purpose of sealing the building aperture tightly, it was hitherto necessary for the material of the entire sealing element to be elastic enough to reliably seal even the corner areas of a building aperture. Owing to the projections pursuant to the invention, the sealing element in the corner areas expands only as much as the sealings on the lateral surfaces, hence requiring the sealing element to be only elastic enough to tightly seal the lateral surfaces of the building aperture. Thus the sealing element can have a lower coefficient of extension and as a result is cheaper than the material hitherto used for sealing elements.

Basically there are several options for creating projections of such kind. According to one embodiment of the invention, the projection is formed from an additional sealing part. These variants can be used particularly if the sealing element is designed as a one piece element extending all around the periphery of the frame. Alternatively, the sealing element can have a butt joint in at least one corner area of the frame, wherein the adjoining sealing element parts are connected, preferably vulcanized to one another non-detachably, on their corresponding cut surfaces and wherein, owing to the projection—in a normal view of the frame—the sum of the angles that include the cut surfaces that are not yet connected to the outer edges of the sealing element parts is smaller than the angle of the outer edges of the sealing element parts that are not yet connected.

Another option that meets the requirements on the extensibility of the sealing element in the corner area and on the lateral surfaces of the frame is provided by an additional embodiment of the invention, in which the sealing element is compressed at least in certain sections, preferably in the corner areas of the frame.

Simply put, these measures—either the provision of a projection or the compressed design of the sealing element—reduce the recurrent tension that occurs in the former areas of the sealing element as a result of the necessary expansion. This firstly increases the lifespan of the sealing element and secondly allows a choice of cost-effective materials.

For the purpose of facilitating the handling of the sealing device during the mounting process and also during manufacturing and transportation, the sealing plate is designed in the form of a lightweight honeycombed plate, preferably formed of plastic composites. Essentially, light and stable materials are used for the frame profile. In case of the use of plastic, the frame can be manufactured in an injection molding process.

If the device can be permanently connected to the building and is displaceably and/or swivelably mounted between a position that closes the building aperture and a position that uncovers the building aperture, at least partly, the device can be opened completely or partially and can also be closed quickly in cases of emergency. The sealing device can alternatively have a flap and/or beam structure that is connected on one side by means of fittings on the pivotal point to the surrounding brickwork and/or the window or door frames. By providing an appropriate visual design to the sealing plate, the device for sealing building apertures can also replace conventional window shutters.

Other features which are considered as characteristic for the invention are set forth in the appended claims.

Although the invention is illustrated and described herein as embodied in a device for sealing building apertures, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1A and 1B illustrate schematically the arrangement of a sealing device in accordance with the invention in a building aperture,

FIGS. 2A and 2B illustrate two different arrangement options of a supporting frame structure with a shell-shaped sealing element on the sealing plate,

FIGS. 3A and 3B illustrate two different arrangement options of an undercut frame profile with a tubular sealing element on a sealing plate,

FIGS. 4A and 4B illustrate perspectively two different designs of the corner areas of the sealing element,

FIGS. 5A, 5B, and 5C illustrate additional embodiments of the invention,

FIG. 6 illustrates a device in accordance with the invention with locking elements,

FIGS. 7A and 7B illustrate essentially the swivelable and/or displaceable arrangement of the invention in front of a building aperture,

FIG. 8 illustrates a device in accordance with the invention in which the sealing element has a projection, and

FIG. 9 illustrates an additional embodiment of the device in accordance with the invention in a disconnected state; and

FIG. 10 is a partial plan view of the additional embodiment in a connected state.

### DESCRIPTION OF THE PREFERRED EMBODIMENTS

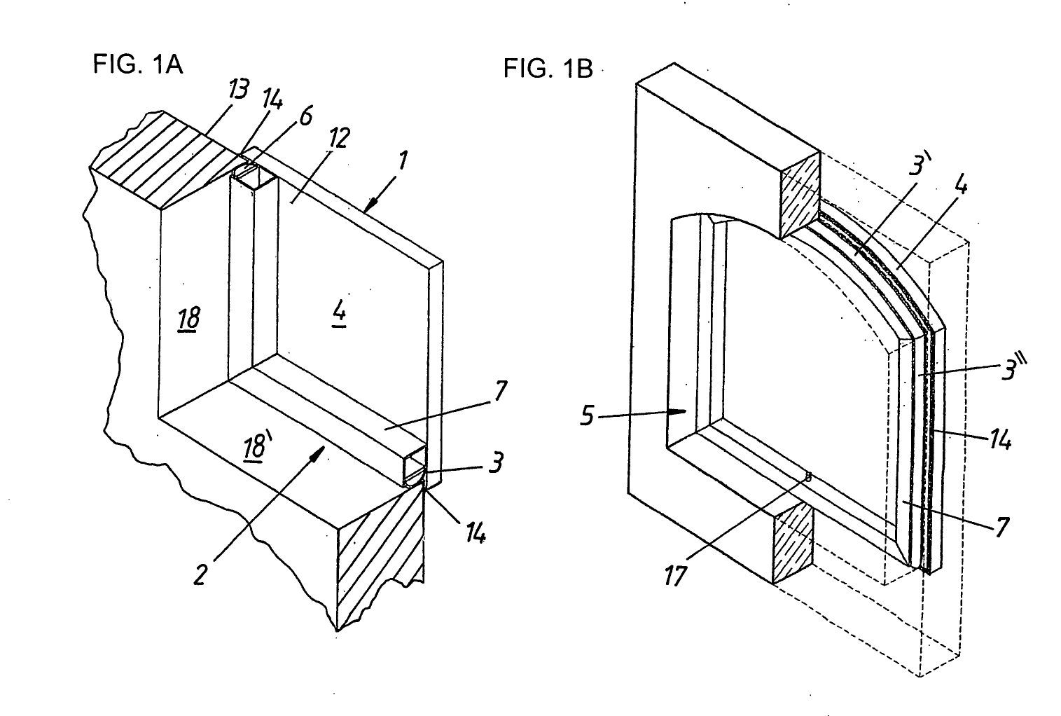

Referring now to the figures of the drawing in detail and first, particularly, to FIGS. 1A and 1B thereof, there is shown a device 1 in accordance with the invention mounted in a building aperture 5. The sealing plate 4 that is designed to be larger than the building aperture 5 rests against the building outer wall 13. A rubber-elastic sealing 14 is arranged between the sealing plate 4 and the building outer wall 13. The frame 2 is arranged on a cover surface 12 of the sealing plate 4. The frame 2 that is designed in the illustrated embodiment as a supporting frame structure 7 can be attached to the sealing plate 4, for instance, by means of adhesion. Other attachment options, such as for instance a mechanical attachment by means of screws are also possible.

The size of the frame 2 corresponds to the dimensions of the building aperture, however it is smaller than the latter. A rubber-elastic, shell-shaped sealing element 3 is arranged on the supporting frame structure 7 on the sides turned toward the soffits 18 and 18′ of the building aperture 5. The shell-shaped sealing element 3 and the supporting frame structure 7 together form a preferably closed, preferably gas-tight chamber 6 into which gaseous, viscous and/or liquid media, for instance air, PV-foam etc. are introduced via the valve 17. The pressure developing in the gas-tight chamber 6 presses the sealing element 3 against the soffits 18, 18′ of the building aperture 5. This simultaneously ensures a fixing of the device 1 in the building aperture 5 and a sealing of the building aperture from solid, liquid and gaseous substances.

It goes without saying that the application of the device in accordance with the invention is not only confined to the closure of building apertures but also additional areas of application can be found wherever there is a necessity to seal off spaces from other spaces or outwards, for instance in boat building, vehicle and aircraft construction, laboratories, for sealing furniture, window and door sealings, room partition walls, tunnel construction and mining industries as well as for sealing stationary or mobile boxes, for instances, containers. In doing so, a wide variety of arrangements including different shapes of polygons, corner angles, curvatures and quadrants can be implemented.

The low weight, the simple structure and the inflatable sealing element that serves for the purpose of attachment and creating impermeability requires no preassembly and enables the mounting of even larger sealing devices by a single person. Light and stable materials are used for manufacturing the sealing structure usually following construction dimensions. Thus the sealing plate can be manufactured, for instance, from lightweight honeycombed plates comprising either plastic or aluminum. In case of the use of plastic, the frame can be manufactured in an injection molding process. The material for the sealing element is usually rubber-elastic and almost gas-tight so that it has the required expansibility and/or elasticity in case of an increase in the internal pressure in the gas-tight chamber.

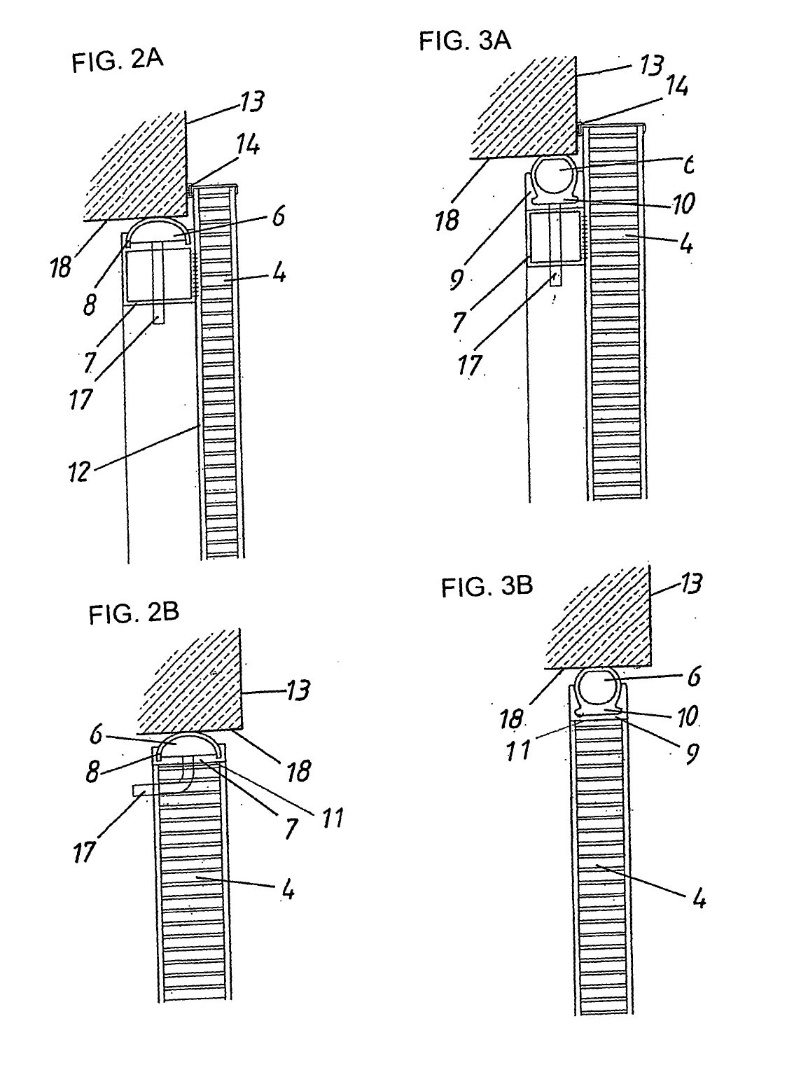

In the embodiments illustrated in FIGS. 2A and 2B, the frame is formed from a supporting frame structure 7 and the sealing element from a semi-circular, bent, elastic shell 8. The frame structure 7 and the shell 8 together form the closed, preferably gas-tight chamber 6. Furthermore, in the frame structure 7, a valve 17 is arranged with which gaseous, viscous and/or liquid media are introduced into the gas-tight chamber 6.

In the example according to FIG. 2A, the frame structure 7 is arranged on a cover surface 12 of the sealing plate 4. Alternatively however, as has been illustrated in FIG. 2B, the frame structure 7 can be arranged on a side surface 11 of the sealing plate 4. This variant has proved to be particularly advantageous if the frame structure 7 is manufactured as a single piece with the sealing plate 4. In addition to the illustrated semi-circular design of the rubber-elastic shell 8, even a U-shaped design of the shell 8 would satisfy the purpose of the invention.

The embodiments illustrated in FIGS. 3A and 3B differ from those illustrated in FIGS. 2A and 2B merely by the different design of the frame. In the embodiment according to FIG. 3B, the frame is built from an undercut, flexible frame profile 9 that serves as a guide to a tubular sealing element 10. The undercut frame profile 9 is arranged, like in FIG. 2B, on a lateral surface 11 of the sealing plate 4. Hence for the purpose of increasing the stability of the frame with respect to the excess pressure present in the gas-tight chamber 6, a supporting frame structure 7 is arranged on the sides of the undercut frame profile 9 turned away from the soffits.

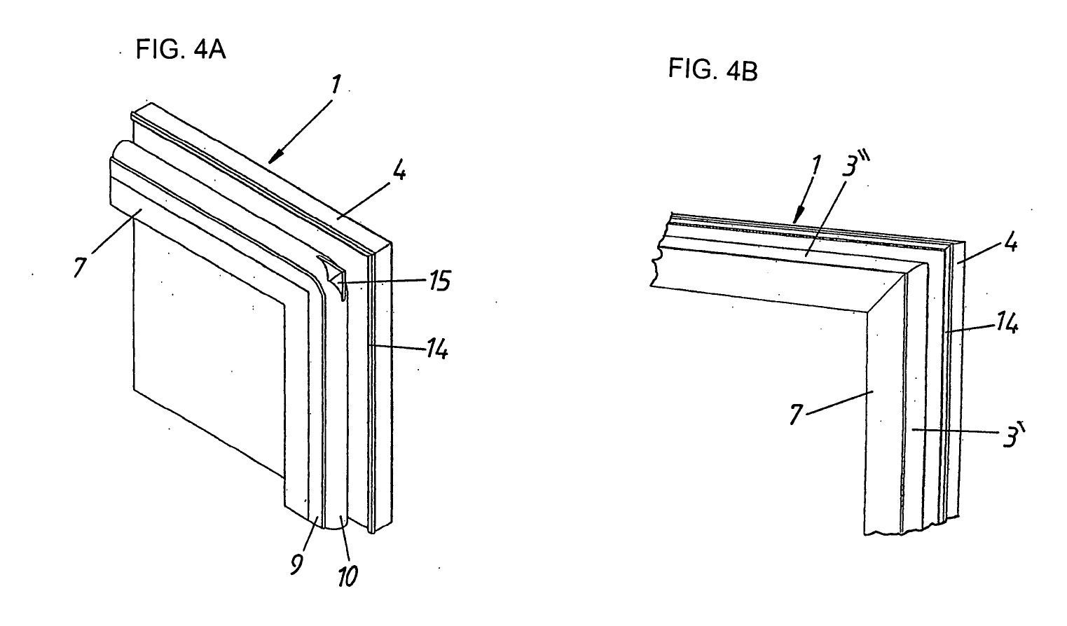

FIGS. 4A and 4B illustrate two different corner designs of a device 1 in accordance with the invention. In the device 1 illustrated in FIG. 4A, the frame is built from an undercut frame profile 9 and a tubular sealing element 10 extending all around its periphery. For the purpose of sealing the corners of the building aperture, the sealing element in the corner areas has an additional sealing part 15 that is glued to the sealing element 10, preferably vulcanized onto it. In the embodiment in accordance with FIG. 4B, the frame is built from a supporting frame construction 7 and the sealing element from a rubber-elastic shell 8. Here the sealing element in the corner areas is mitred wherein the two sealing element parts 3′, 3″ are glued, preferably vulcanized to one another non-detachably, on their corresponding cut surfaces.

Gaseous, liquid and/or viscous media can be introduced manually into the preferably gas-tight chamber 6 using conventional valves. Alternatively, this supply process can also take place automatically, wherein the pressure supply can be monitored by means of pressure gages and/or pressure limiting elements.

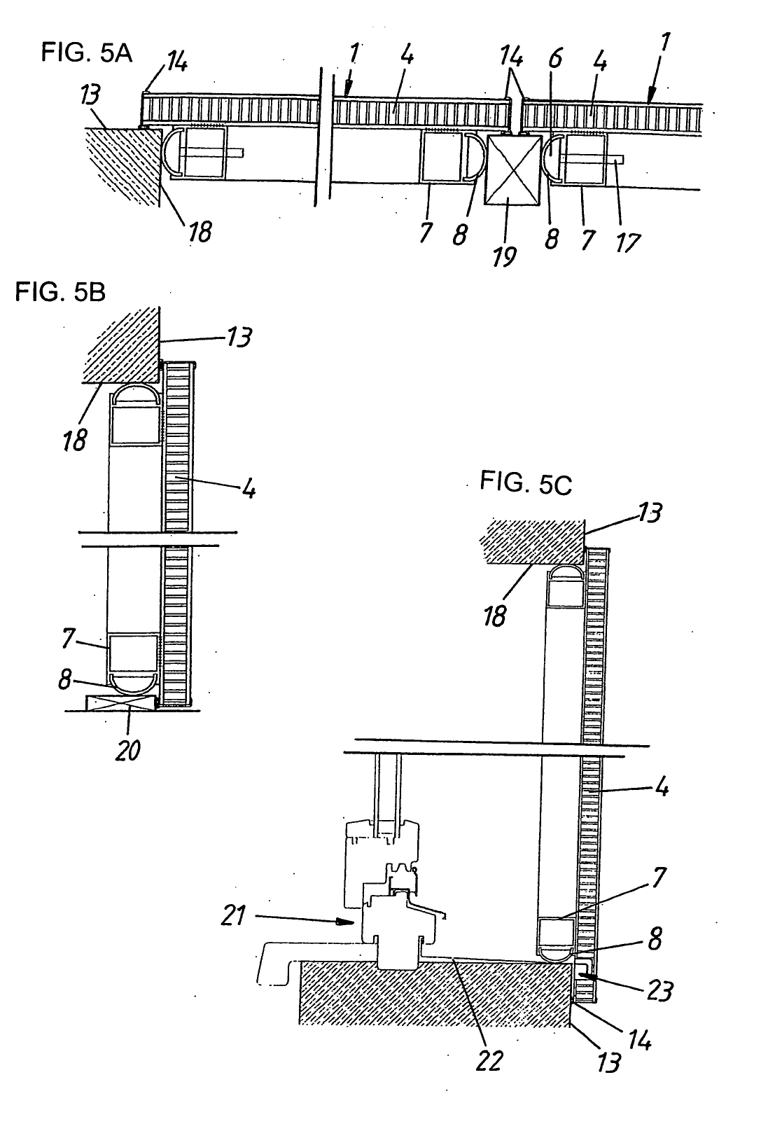

FIGS. 5A to 5C illustrate additional embodiments of the invention that enable the adjustment of the sealing device to different constructional conditions. Thus in case of large building apertures, as illustrated in FIG. 5A, the apertures can be divided using bars 19. This makes it possible to limit the size of the sealing device 1 to a standard dimension, thus enabling its assembly by a single person. In the embodiment illustrated in FIG. 5B, the building aperture reaches to the ground. Hence the sealing plate 4 has no stop. This problem occurs frequently in case of window displays or building entrances and is solved by arranging a ground rail 20, as illustrated in FIG. 5B. This ground rail 20 does not have to be attached to the ground since it is pressed firmly against the ground as a result of the excess pressure created in the chamber 6. It can be seen in FIG. 5C, that in case of building apertures in which a window 21 is arranged with a windowsill 22, the sealing plate 4 has a recess 23 for accommodating the part of the windowsill 22 projecting over the building outer wall 13. Due to the honeycombed design of the sealing plate 4, this recess 23 does not affect the stability of the sealing plate 4 adversely.

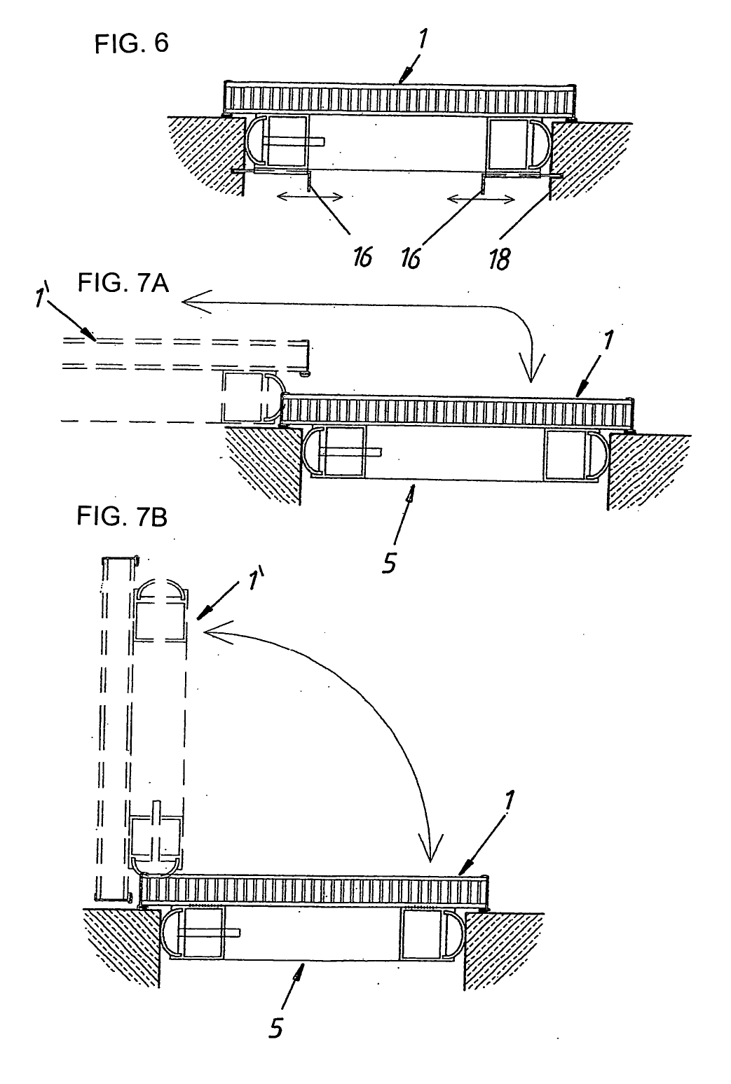

FIG. 6 illustrates a burglar-proof variant of the device in accordance with the invention, in which on the side of the frame turned toward the interior of the building, locking elements 16 are arranged that can be connected to the surrounding brickwork and/or window and door frames. Apart from the variant with the locking elements illustrated, even the arrangement of a latch connection or a screw connection is possible.

FIGS. 7A and 7B schematically illustrate a permanent arrangement of the device 1 in the area of the building aperture 5, wherein the device 1 in accordance with FIG. 7A is mounted displaceably, for instance by means of a beam structure between a in-use position that closes the building aperture 5 and an open position that uncovers the building aperture at least partially. This mounted position of the device is indicated by the dotted line in FIG. 7A.

In accordance with FIG. 7B, the device 1 can be moved between a position closing the building aperture 5 and a position (dotted line) uncovering the building aperture. As opposed to FIG. 7A, the device 1 in accordance with FIG. 7B is attached swivelably, for instance by means of pivotal point fittings to the surrounding brickwork.

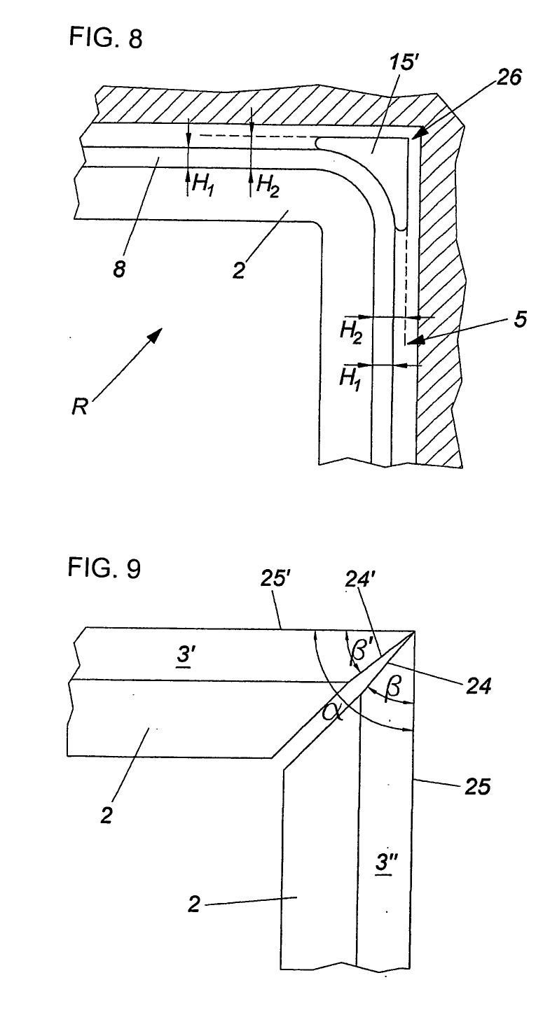

FIG. 8 illustrates another embodiment of the invention in which the sealing element 8 has a projection 26 that is formed from an additional sealing element 15′. In doing so, the normal distance H₂ of the projection 26 from the adjoining longitudinal edges of the frame 2 is larger than the normal distance H₁ of the areas of the sealing element 6 that extend along the longitudinal edges from the longitudinal edges of the frame 2. The larger expansion required in case of sealing elements without a projection in the corner areas of the frame as opposed to the areas extending along the longitudinal edges is prevented in the illustrated embodiment. This is because the projection 26 protrudes even in the deflated state beyond the difference between H₂ and H₁. In the assembly of the device pursuant to the invention, the frame 2 is inserted with the sealing element 8 into the building aperture 5 such that the projection 26 rests against the wall of the building aperture 5. During inflation the sealing element 8 expands into the areas extending along the longitudinal edges until it rests against the wall of the building aperture.

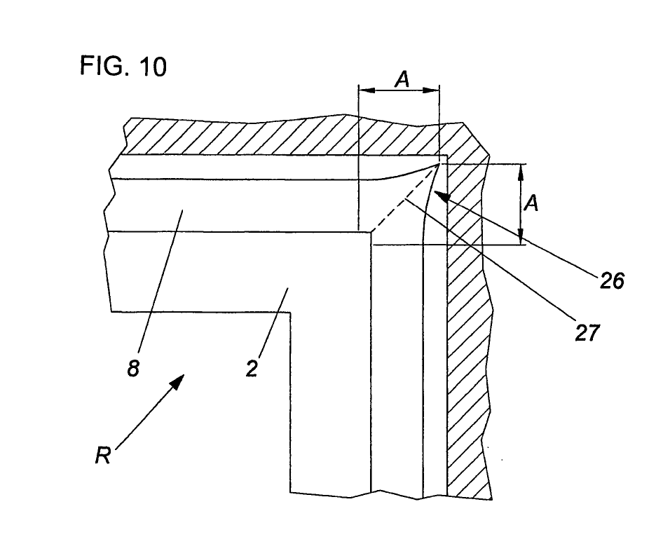

FIGS. 9 and 10 illustrate an additional embodiment in which the projection 26 in accordance with the invention is formed as follows: The sum of the angles β, β′ that include the cut surfaces 24, 24′ that are not yet connected to the outer edges 25, 25′ of the sealing element parts 3, 3′ is smaller than the angle a of the outer edges 25, 25′ of the sealing element parts 3′, 3″ that are not yet connected. If, as illustrated in FIG. 10, the sealing elements parts 3′, 3″ are connected to one another, a butt joint 27 is formed wherein as a result of the incorrect miter cut, the sealing element 8 forms a projection 26. An additional advantage of an embodiment of such type is that the sealing element 8 in the corner areas is compressed in certain sections so that the expansion caused as a result of the inflation of the sealing element 8 is compensated at least in part in these areas A.

It must be pointed out here that the figures are but representative illustrations from which the actual dimensions of the device according to the invention cannot be inferred. It will be understood that the invention is not limited to the embodiments illustrated. Thus it also possible, for instance, to arrange inflatable sealing elements on only two sides of the frame and elastic non-inflatable sealing elements on the other two opposite sides of the frame. The sealing of the corner areas can also be completely omitted. It is also possible to seal off the corner areas exclusively. The prerequisite for the aforementioned variants of arranging the sealing device is that the sealing arranged between the sealing plate and the building outer wall takes over the sealing function of the sealing element described in the claims. Furthermore, it would be possible to integrate into the soffits of the building apertures a vacuum frame to suck the sealing element into the frame and thus create the impermeability between the frame and the window soffit.

1. A device for sealing a building aperture, comprising:
a frame configured for adjustment to an inner clearance of the aperture; and
a sealing plate firmly connected to said frame;
said frame having an inflatable sealing element forming at least one lateral surface facing towards a boundary surface of the building aperture, said sealing element having an open cross-section and forming a closed chamber with at least one frame part of said frame.

2. The device according to claim 1, wherein said sealing element is a rubber-elastic shell with an open cross-section extending completely around a periphery of said frame.

3. The device according to claim 1, wherein said chamber is a gas-tight chamber.

4. The device according to claim 1, wherein said frame includes a supporting frame structure, and said supporting frame structure and said sealing element together forming a gas-tight chamber, to be arranged between the building aperture and said supporting frame structure.

5. The device according to claim 1, wherein said sealing element has a substantially semi-circular profile cross-section.

6. The device according to claim 1, wherein said frame is formed with an undercut and said sealing element is disposed in said undercut.

7. The device according to claim 6, wherein said frame has a flexible frame profile and said sealing element is a tubular sealing element guided in said undercut.

8. A device for sealing a building aperture, comprising:
a frame configured for adjustment to an inner clearance of the aperture; and
a sealing plate firmly connected to said frame;
said frame being formed with an undercut and having an inflatable sealing element forming at least one lateral surface facing towards a boundary surface of the building aperture, said sealing element being disposed in said undercut.

9. The device according to claim 8, wherein said frame has a flexible frame profile and said sealing element is a tubular sealing element guided in said undercut.

10. The device according to claim 8, wherein said frame has a supporting frame structure rigidly connected to at least one of a frame profile and said sealing element.

11. The device according to claim 1, wherein said sealing plate has lateral surfaces and said frame is tightly connected to said lateral surfaces of said sealing plate.

12. The device according to claim 11, wherein said frame is glued to said sealing plate around an entire periphery thereof.

13. The device according to claim 1, wherein said frame is tightly connected on a cover surface of said sealing plate.

14. The device according to claim 13, wherein said frame is glued to said sealing plate said sealing plate.

15. The device according to claim 13, wherein said sealing plate is larger than the building aperture.

16. The device according to claim 15, which comprises an elastic seal disposed between a part of said sealing plate overlapping the building aperture and a building outer wall.

17. The device according to claim 1, wherein said sealing element includes additional sealing parts disposed in corner areas of the building aperture.

18. The device according to claim 1, wherein said sealing element has sealing element parts formed with miters in corner areas of the building aperture and said sealing element parts are glued together on corresponding cut surfaces thereof.

19. The device according to claim 8, wherein said sealing element parts are vulcanized to one another.

20. The device according to claim 1, wherein said sealing element has a projection in a deflated state thereof in at least one corner area of said frame.

21. The device according to claim 20, wherein said projection is formed from an additional sealing part.

22. The device according to claim 20, wherein said sealing element has a butt joint in the corner area of said frame, wherein adjoining sealing element parts are connected, on corresponding cut surfaces and wherein, in a normal view of said frame, a sum of miter angles enclosing said cut surfaces not yet connected to outer edges of said sealing element parts is smaller than an angle of the outer edges of said sealing element parts that are not yet connected.

23. The device according to claim 1, wherein said sealing element is compressed at least in given portions thereof.

24. The device according to claim 23, wherein said sealing element is compressed in corner areas of said frame.

25. The device according to claim 1, wherein said sealing plate is lightweight honeycomb plate.

26. The device according to claim 1, permanently connected to the building displaceably and/or swivelably mounted between a first position closing the building aperture and a second position at least partly uncovering the building aperture.
